(19) United States
(12) Patent Application Publication
(10) Pub. No.: US 2026/0331034 A1
(43) Pub. Date: Oct. 22, 2026

(54) ELECTRONIC DEVICE

(71) Applicant: InnoLux Corporation, Miao-Li County (TW)

(72) Inventors: Sheng-Feng HUANG, Miao-Li County (TW); Cheng-Hsiao LIN, Miao-Li County (TW); Pei-Chih LIU, Miao-Li County (TW)

(73) Assignee: InnoLux Corporation, Miao-Li County (TW)

(21) Appl. No.: 19/562,744

(22) Filed: Mar. 10, 2026

(30) Foreign Application Priority Data
Apr. 17, 2025 (CN) 202510481845.5

(51) Int. Cl. G09G 3/32

(52) U.S. Cl. CPC G09G 3/32; G09G 2300/0842; G09G 2310/0286; G09G 2310/08; G09G 2320/0247; G09G 2330/04

(57) ABSTRACT

An electronic device includes a plurality of rows of electronic units, a plurality of scan drivers, and a multi-stage shift register. Each row of electronic units includes a plurality of electronic units. Each scan driver is electrically connected to at least one row of the plurality of rows of electronic units. The multi-stage shift register is electrically connected in a cascade manner, with each stage of the shift register providing a first signal to at least one row of the plurality of rows of electronic units, and providing a second signal to one of the plurality of scan drivers. Each scan driver outputs a scan signal to at least one row of the plurality of rows of electronic units based on the second signal.

### BACKGROUND OF THE DISCLOSURE

### 1. Field of the Disclosure

The present disclosure relates to an electronic device, particularly to an electronic device capable of performing hybrid driving using pulse amplitude modulation and pulse width modulation.

### 2. Description of the Prior Art

With the proliferation of electronic products, display devices have become an essential component of modern technology. Display devices are controlled using two main driving methodologies: Pulse Amplitude Modulation (PAM) and Pulse Width Modulation (PWM). However, both methodologies present distinct limitations.

Although pulse amplitude modulation driving provides continuous current flow, it generates color deviation issues under low current conditions, presenting a significant challenge for applications requiring precise color display.

Pulse width modulation driving facilitates brightness adjustment through rapid switching operations. However, when the duty cycle is excessively low, the actual emission duration becomes insufficient, potentially resulting in flickering or unstable visual phenomena. This deficiency is particularly pronounced in high-speed photography environments or applications requiring consistently stable light sources.

### SUMMARY OF THE DISCLOSURE

An embodiment provides an electronic device including a plurality of rows of electronic units, a plurality of sweep drivers, and a plurality of shift registers. Each row of electronic units includes a plurality of electronic units. Each sweep driver is electrically connected to at least one row of the plurality of rows of electronic units. The plurality of shift registers are electrically connected in a cascade manner to form a multi-stage structure. Each shift register is used to provide a first signal to at least one row of the plurality of rows of electronic units, and provide a second signal to one of the plurality of sweep drivers. Each sweep driver outputs a sweep signal to at least one row of the plurality of rows of electronic units based on the second signal.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram of an electronic device according to an embodiment.

FIG. 2 is a schematic diagram of an electronic unit according to an embodiment.

FIG. 3 is a signal waveform diagram of the circuit in FIG. 1 and FIG. 2 according to an embodiment.

FIG. 4 is a schematic diagram of an electronic unit according to an embodiment.

FIG. 5 is a signal waveform diagram of the circuit in FIG. 4.

FIG. 6 is a schematic diagram of an electronic device according to another embodiment.

FIG. 7 is a signal waveform diagram of the circuit in FIG. 6.

FIG. 8 is a schematic diagram of a shift register receiving odd-stage signals according to an embodiment.

FIG. 9 is a schematic diagram of a shift register receiving even-stage signals according to an embodiment.

FIG. 10 is a schematic diagram of a sweep driver according to an embodiment.

FIG. 11 is a schematic diagram of a sweep driver according to another embodiment.

FIG. 12 is a timing diagram of signals of the sweep driver in FIG. 11.

FIG. 13 is a schematic diagram of a display area according to an embodiment.

FIG. 14 is a schematic diagram of an electronic unit according to another embodiment.

FIG. 15 is a cross-sectional schematic diagram of the structure of an electronic unit according to an embodiment.

### DETAILED DESCRIPTION

Pulse amplitude modulation (PAM) driving can control display device brightness by adjusting the magnitude (amplitude) of current. Pulse width modulation (PWM) driving can regulate brightness by controlling the ratio of current switching time (duty cycle), maintaining constant current value while altering the activation time of the light-emitting component. Considering the inherent limitations of pulse amplitude modulation (PAM) driving and pulse width modulation (PWM) driving, embodiments of the disclosure provide a hybrid driving circuit for receiving and processing PAM-related signals and PWM-related signals. This hybrid driving technology combines the advantages of both driving methods, preserving the stability of continuous current output characteristic of PAM driving while maintaining the color accuracy of PWM.

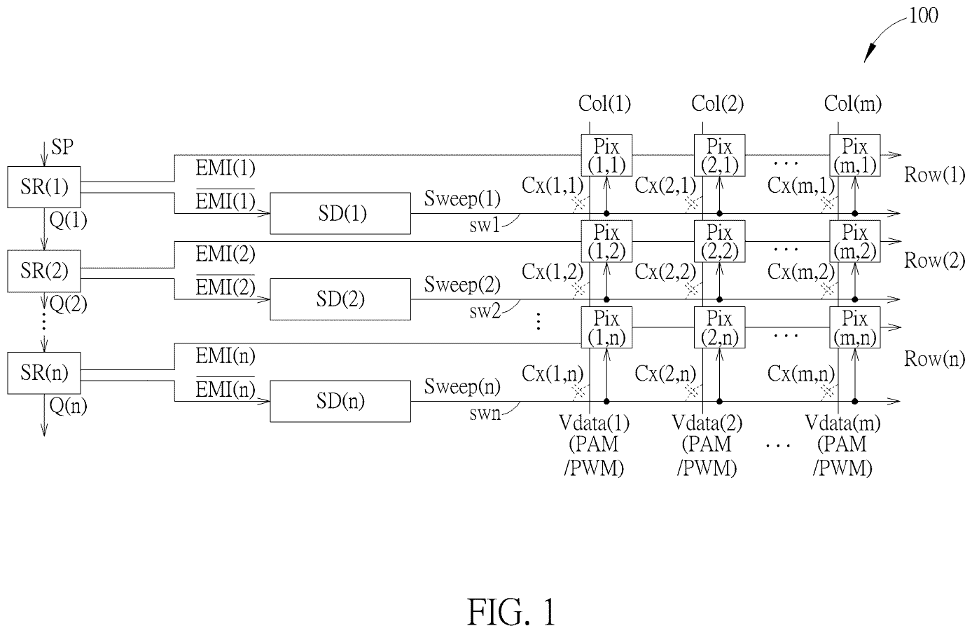

FIG. 1 is a schematic diagram of an electronic device 100 according to an embodiment. The electronic device 100 may include a plurality of rows of electronic units, a plurality of sweep drivers, and a plurality of shift registers forming a multi-stage structure. The electronic device 100 includes rows of electronic units Row(1) to Row(n), sweep drivers SD(1) to SD(n), and shift registers SR(1) to SR(n).

Among the rows of electronic units Row(1) to Row(n), each row may include a plurality of electronic units. For example, the row of electronic units Row(1) may include electronic units Pix(1,1) to Pix(m,1), totaling m electronic units. The row of electronic units Row(2) may include electronic units Pix(1,2) to Pix(m,2), totaling m electronic units, and so on. Here, m and n may be integers greater than 0. The electronic units mentioned in the text may include, but are not limited to, pixel-related circuits. In FIG. 1, electronic units in the first column may be located in a column Col(1), electronic units in the second column may be located in a column Col(2), and so on.

Among the sweep drivers SD(1) to SD(n), each sweep driver may be electrically connected to at least one row of the rows of electronic units Row(1) to Row(n). The shift registers SR(1) to SR(n) may be electrically connected in a cascade manner.

Each stage of the shift registers may be used to output a first signal and a second signal. For example, the shift register SR(1) may provide a first signal EMI(1) and a second signal E̅M̅I̅(̅1̅)̅, the shift register SR(2) may provide a first signal EMI(2) and a second signal E̅M̅I̅(̅2̅)̅, and so on.

Taking the shift register SR(1) as an example, the shift register SR(1) may provide the first signal EMI(1) to at least one row of the rows of electronic units Row(1) to Row(n), for example, the row of electronic units Row(1). The shift register SR(1) may provide the second signal E̅M̅I̅(̅1̅)̅ to one of the sweep drivers SD(1) to SD(n), for example, the sweep driver SD(1).

Each sweep driver may output a sweep signal to at least one row of the rows of electronic units Row(1) to Row(n) based on the corresponding second signal. For example, the sweep driver SD(1) may output a sweep signal Sweep(1) to the row of electronic units Row(1) based on the second signal E̅M̅I̅(̅1̅)̅. The sweep driver SD(2) may output a sweep signal Sweep(2) to the row of electronic units Row(2) based on the second signal E̅M̅I̅(̅2̅)̅, and so on.

The electronic device 100 may also include data line groups Vdata(1) to

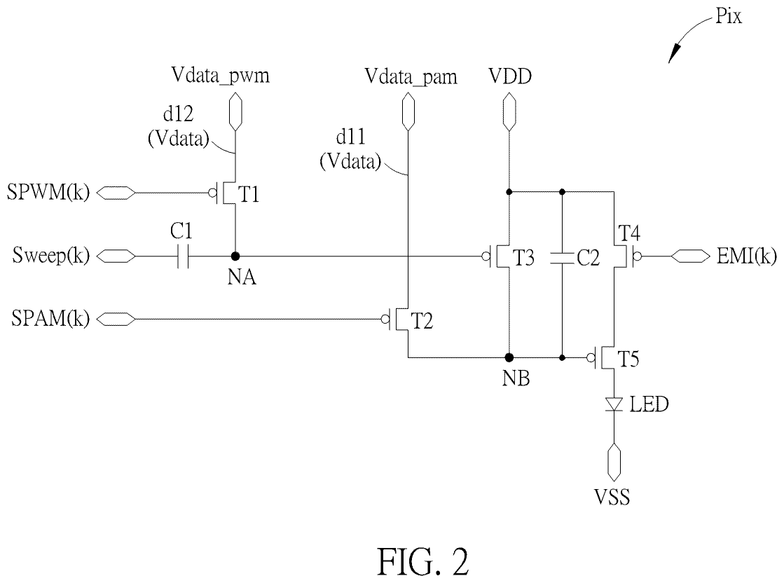

Vdata(m). The data line group Vdata(1) may be coupled to the electronic units Pix(1,1), Pix(1,2), . . . , and Pix(1,n) in the first column. The data line group Vdata(2) may be coupled to the electronic units Pix(2,1), Pix(2,2), . . . , and Pix(2,n) in the second column, and so on. In FIG. 1, each of the data line groups Vdata(1) to Vdata(m) is marked with brackets labeled PAM/PWM, indicating that they can receive pulse amplitude modulation data and pulse width modulation data. As described in FIG. 2 below, each of the data line groups Vdata(1) to Vdata(m) may include two data lines, where one data line of the two data lines transmit pulse amplitude modulation (PAM) data and the other data line provides pulse width modulation (PWM) data, to realize hybrid driving of pulse amplitude modulation and pulse width modulation. Details will be described in the following text.

Among the multi-stage shift registers SR(1) to SR(n), the first stage shift register

SR(1) may be used to receive a start signal SP, and provide a signal Q(1) to the next stage following the first stage shift register SR(1), which is the second stage shift register SR(2). The signal level and waveform of signal Q(1) may be equal to the first signal EMI(1). For example, the signal Q(1) may be inputted to a plurality of inverters, or inputted to a buffer, to generate the first signal EMI(1). Therefore, the waveforms of signal Q(1) and the first signal EMI(1) may be equal, with a delay and phase difference of only hundreds of nanoseconds. If this delay is neglected, the signal Q(1) and the first signal EMI(1) may be considered substantially equal, for example, it can be expressed as Q(1)≈EMI(1), or, Q(1)=EMI(1).

The first signal and the second signal outputted by each shift register are complementary to each other, for example, the first signal EMI(1) and the second signal E̅M̅I̅(̅2̅)̅ outputted by the shift register SR(1) are complementary to each other.

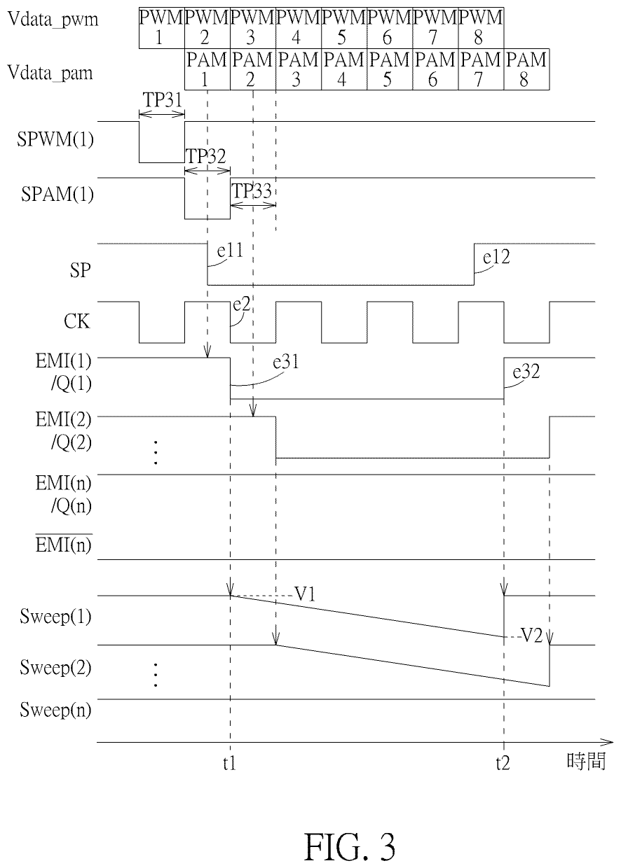

FIG. 2 is a schematic diagram of an electronic unit Pix according to an embodiment. The electronic unit Pix may be one of the electronic units Pix(1,1) to Pix(m,n) in FIG. 1. FIG. 3 is a signal waveform diagram of the circuits in FIG. 1 and FIG. 2 according to an embodiment.

In FIG. 2, it may be considered that the electronic unit Pix is located in the k-th row of electronic units Row(k), as an example. In FIG. 3, to simplify the explanation, k=1 in FIG. 2 may be used as an example.

Therefore, the operations related to the circuit in FIG. 2 may correspond to the signals SPWN(1) and SPAM(1), the first signal EMI(1), the signal Q(1), the start signal SP, the clock signal CK, the pulse width modulation (PWM) signal Vdata_pwm, the pulse amplitude modulation signal (PAM) Vdata_pam, and the sweep signal Sweep(1) in FIG. 3. The related operations are described below.

As shown in FIG. 1 and FIG. 2, the electronic device 100 may include a plurality of first data lines and a plurality of second data lines. The first data lines may be used to send PAM signals to a plurality of electronic units. The second data lines may be used to send PWM signals to the electronic units. For example, the data line group Vdata in FIG. 2 may be one of the data line groups Vdata(1) to Vdata(m) in FIG. 1, and is coupled to the electronic unit Pix in FIG. 2. The data line group Vdata in FIG. 2 may include a first data line d11 and a second data line d12, where the first data line d11 may be used to send the PAM signal Vdata_pam to the electronic unit Pix, and the second data line d12 may be used to send the PWM signal Vdata_pwm to the electronic unit Pix.

Each sweep driver may be electrically connected to at least one row of the plurality of rows of electronic units through at least one sweep signal line. In a top view of the circuit layout, the sweep signal line may intersect with the first data lines and the second data lines. For example, in FIG. 1, the sweep driver SD(1) may be electrically connected to electronic units Pix(1,1) to Pix(m,1) of the row of electronic units Row(1) through the sweep signal line sw1. The sweep signal line sw1 intersects with the first data line d11 and the second data line d12 of the data line group Vdata(1), and parasitic capacitance Cx(1,1) is generated at the intersection. Similarly, the sweep signal line sw1 intersects with the data line group Vdata(2), generating parasitic capacitance Cx(2,1), and so on, as shown in FIG. 1.

As shown in FIG. 2, the electronic unit Pix may include a transistor T1, a transistor T2, a transistor T3, a transistor T4, a transistor T5, a capacitor C1, a capacitor C2, and a light-emitting unit LED, coupled as shown in FIG. 2. The transistor T1, the transistor T2, the transistor T3, the transistor T4, and the transistor T5 may be p-type transistors. The light-emitting unit LED may include a light-emitting diode.

To simplify the explanation, k in FIG. 2 may be 1, for example, and the electronic unit Pix may be located in the row of electronic units Row(1) in FIG. 1. Therefore, the sweep signal Sweep(k) in FIG. 2 may correspond to the sweep signal Sweep(1) in FIG. 1 and FIG. 3, and the signal EMI(k) in FIG. 2 may correspond to the first signal EMI(1) in FIG. 1 and FIG. 3. Here, k=1 is only an example, but embodiments are not limited thereto, and k may be any integer from 1 to n.

A first terminal of the capacitor C1 may be configured to receive the sweep signal

Sweep(k). The transistor T1 may be configured to receive the PWM signal Vdata_pwm. The transistor T2 may be configured to receive the PAM signal Vdata_pam. The transistor T1 and the capacitor C2 may be coupled to a node NA between a second terminal of the capacitor C1 and the transistor T3. The transistor T2 and the transistor T3 may be coupled to a node NB.

FIG. 3 is a signal waveform diagram of the circuits in FIG. 1 and FIG. 2. The horizontal axis in FIG. 3 is a time axis. The following description explains how to achieve hybrid driving of Pulse Amplitude Modulation (PAM) and Pulse Width Modulation (PWM) through the operations shown in FIG. 3.

In FIG. 2 and FIG. 3, the signal SPWM(1) may control the transistor T1, and the signal SPAM(1) may control the transistor T2, to determine when the PWM signal Vdata_pwm and the PAM signal Vdata_pam are inputted to the node NA and the node NB.

In FIG. 3, the PWM data (e.g. data PWM1) may be inputted one data cycle earlier than the PAM data (e.g. data PAM1), where one data cycle may be half of a clock cycle. The start signal SP may be used to trigger the first-stage shift register SR(1), and the subsequent stage shift registers may be triggered by the preceding stage shift registers.

During a period TP31, the signal SPWM(1) is at a low state, and the transistor T1 in FIG. 2 may be turned on, at which time the sweep signal Sweep (corresponding to the sweep signal Sweep(1) in FIG. 3) has not yet been activated, and the data PWM1 of the PWM signal Vdata_pwm may be stored at the node NA.

For example, the power signal VDD in FIG. 2 may be 5 volts. If the data stored in the node NA is 1 volt, the difference between 5 volts and 1 volt may exceed the threshold voltage of the transistor T3, potentially causing the transistor T3 to be erroneously turned on. Therefore, the data stored in the node NA should be sufficiently large to avoid erroneously turning on the transistor T3. For example, the PWM signal Vdata_pwm may be greater than 4 volts. Thus, according to embodiments, the voltage value of the PWM signal Vdata_pwm may be greater than the voltage value of the PAM signal Vdata_pam, and it may be determined according to the power signal VDD.

During a period TP32, the signal SPAM(1) is at a low state. The transistor T2 in

FIG. 2 may be turned on, and the data PAM1 of the PAM signal Vdata_pam may be stored in the node NB. The start signal SP may transition from a high state to a low state, corresponding to the signal edge e11 of the start signal SP. At the signal edge e2 of the clock signal CK, the first signal EMI(1) may undergo a level change, producing signal edge e31. The start signal SP may be at a low state between signal edges e11 and e12. The time duration between signal edges e11 and e12 of the start signal SP may determine the interval length of the level change of the first signal EMI(1), which is the time duration between signal edges e31 and e32 of the first signal EMI(1). In FIG. 3, this time duration may be three clock cycles.

After the first signal EMI(1) changes level at the signal edge e31, the transistor T4 may turn on, after which, the transistor T5 will correspondingly activate. The first signal EMI(1) may include a pulse between a time t1 (corresponding to the signal edge e31) and a time t2 (corresponding to the signal edge e32). The sweep signal Sweep(1) may transition from a voltage V1 to a voltage V2 with a predetermined slope between the time t1 and the time t2. When the sweep signal Sweep(1) decreases to a specific level, the transistor T3 may turn on, allowing the high-level signal of the power signal VDD to be transmitted to the node NB, thereby turning off the transistor T5. The control mechanism related to the slope of the sweep signal Sweep(1) decreasing between the time t1 and the time t2 will be described in the following text.

As shown in FIG. 3, during a period TP31, the data PWM1 may first be inputted through the PWM signal Vdata_pwm. Subsequently, during a period TP32, data PWM2 may be inputted through the PWM signal Vdata_pwm, while simultaneously inputting data PAM1 through the PAM signal Vdata_pam. Later, during a period TP33, data PWM3 may be inputted through the PWM signal Vdata_pwm, while simultaneously inputting data PAM2 through the PAM signal Vdata_pam, and so on.

In FIG. 2 and FIG. 3, circuit control based on the PWM signal Vdata_pwm may be implemented through the transistor T1, the transistor T3, and the capacitor C1. Circuit control based on the PAM signal Vdata_pam may be implemented through the transistor T2, the transistor T5, and the capacitor C2. The transistor T5 may be turned off at an appropriate time through the level decrease of the sweep signal Sweep. As a result, the electronic unit Pix can be controlled by both the PAM signal Vdata_pam and the PWM signal Vdata_pwm. This implementation achieves hybrid driving of PAM and PWM to control light emission.

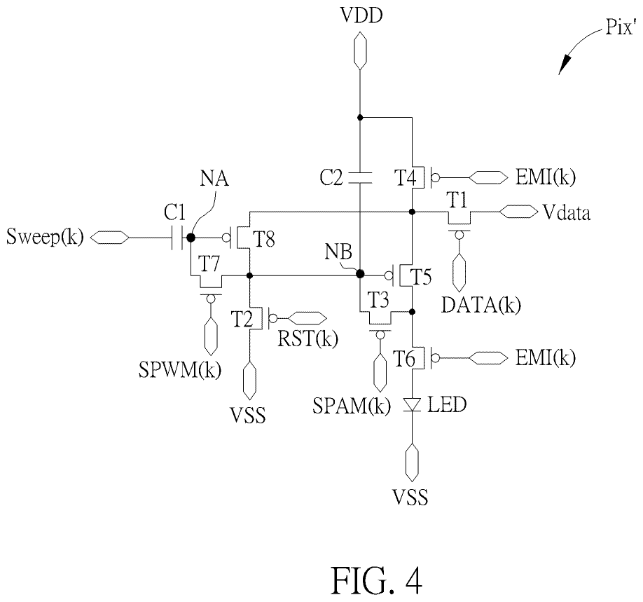

FIG. 4 is a schematic diagram of an electronic unit Pix′ according to an embodiment. The electronic unit Pix′ may be applied to the architecture in FIG. 1. The electronic unit Pix′ may be one of the electronic units Pix(1,1) to Pix(m,n) in FIG. 1. The electronic unit Pix′ may compensate for the threshold voltages (commonly denoted as Vth) of the transistor T5 and the transistor T8, which means it may reduce the unintended effects of process variations and errors on circuit operation. The electronic unit Pix′ may include a transistor T1 to a transistorT8, a capacitor C1, a capacitor C2, and a light-emitting unit LED, coupled as shown in FIG. 4.

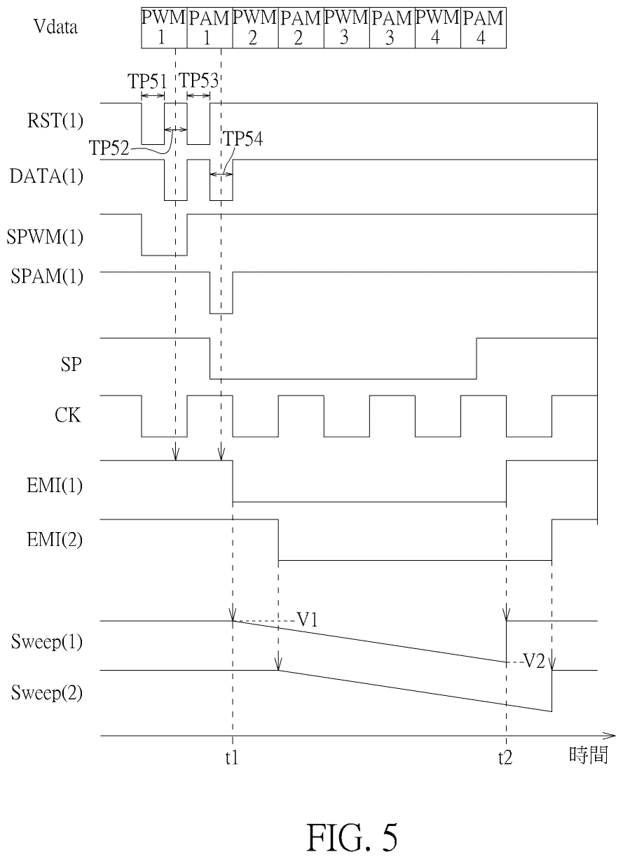

The electronic unit Pix′ in FIG. 4 may be located in the k-th row of electronic units Row(k) in FIG. 1. FIG. 5 is a signal waveform diagram of the circuit in FIG. 4 according to an embodiment. When explaining the operation of FIG. 4 using the waveforms in FIG. 5, k in FIG. 4 may be 1, as an example, to simplify the explanation. Here, k=1 is only an example, as k may be any integer from 1 to n.

As shown in FIG. 5, an input terminal for receiving the signal Vdata mentioned in FIG. 4 and FIG. 5 may sequentially and alternately receive PWM data PWM1, PAM data PAM1, PWM data PWM2, PAM data PAM2, . . . , and so on.

During a period TP51, the reset signal RST(1) may have a pulse (for example, at a low state) to perform a reset operation. In the period TP51, the transistor T2 and the transistor T7 may be turned on, and the ground signal VSS may be written to the node NA to reset the node NA.

During the period TP52, the transistor T2 is turned off while the transistor T7 remains on. Since the signal DATA(1) is at a low state, the transistor T1 is turned on, while the transistor T5 and the transistor T3 are turned off. The data from the signal Vdata (for example, the data PWM1) can be written to the node NA. For instance, if the signal Vdata is 2 volts, since both the transistor T7 and the transistor T8 are turned on, they form a structure where the gate terminal is electrically connected to the drain terminal. This allows the data from the signal Vdata to be written to the node NA through the transistor T1, the transistor T8, and the transistor T7. During this process, the 2 volts of the signal Vdata is reduced by the threshold voltage of the transistor T8 (for example, 1 volt), resulting in 1 volt of data being written to the node NA. Through this operation, threshold voltage compensation is achieved.

During the period TP53, the reset signal RST(1) may have a pulse (for example, at a low state) to perform a reset operation again, causing the node NB to have the level of the ground signal VSS.

During the period TP54, the signal DATA(1) is at a low state, enabling the transistor T1 to turn on. The signal SPAM(1) has a pulse (for example, at a low state), which turns on the transistor T3. The signal Vdata can be written to the node NB through the transistor T1, the transistor T5, and the transistor T3. For instance, if the signal Vdata is 2 volts, after subtracting the threshold voltage of the transistor T5 (for example, 1 volt), 1 volt can be written to the node NB. During the period TP54, threshold voltage compensation is achieved at the node NB. Similar to FIG. 3, in FIG. 5, between the time t1 and the time t2, the sweep signal Sweep(1) transitions from the voltage V1 to the voltage V2 with a predetermined slope.

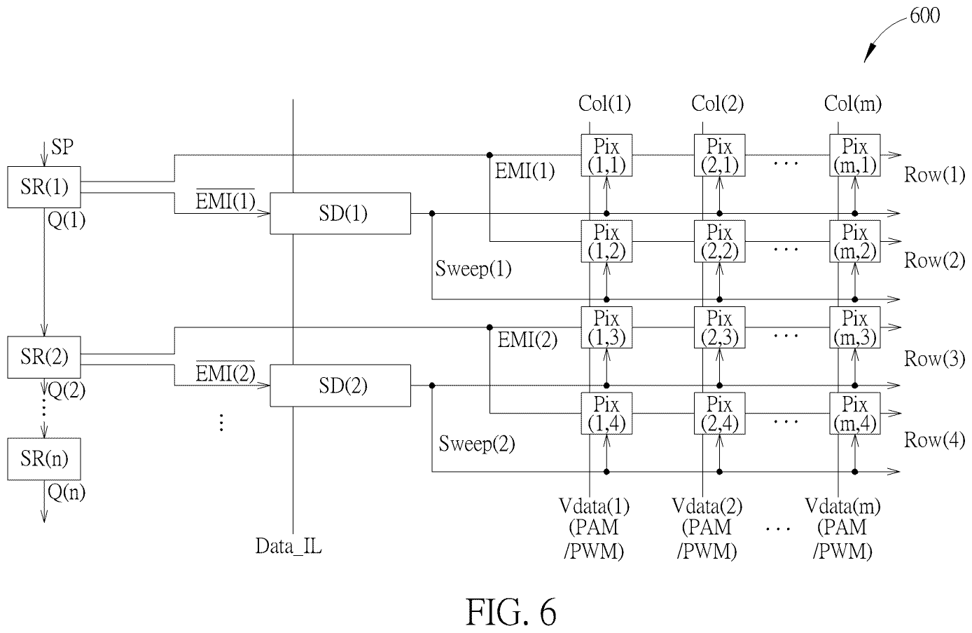

FIG. 6 is a schematic diagram of an electronic device 600 according to another embodiment. Comparing FIG. 1 and FIG. 6, each stage of the shift registers in FIG. 1 corresponds to one row of electronic units, while each stage of the shift registers in FIG. 6 corresponds to two rows of electronic units. Therefore, FIG. 6 is a one-to-two architecture. In FIG. 6, each stage of the shift registers can provide the first signal to at least two rows of the plurality of rows of electronic units, and each sweep driver can output the sweep signal to at least two rows of the plurality of rows of electronic units. For example, the shift register SR(1) in FIG. 6 can provide the first signal EMI(1) to the row of electronic units Row(1) and the row of electronic units Row(2). The sweep driver SD(1) can output the sweep signal Sweep(1) to the row of electronic units Row(1) and the row of electronic units Row(2). The circuit structure in FIG. 6 can address the problem of limited layout space.

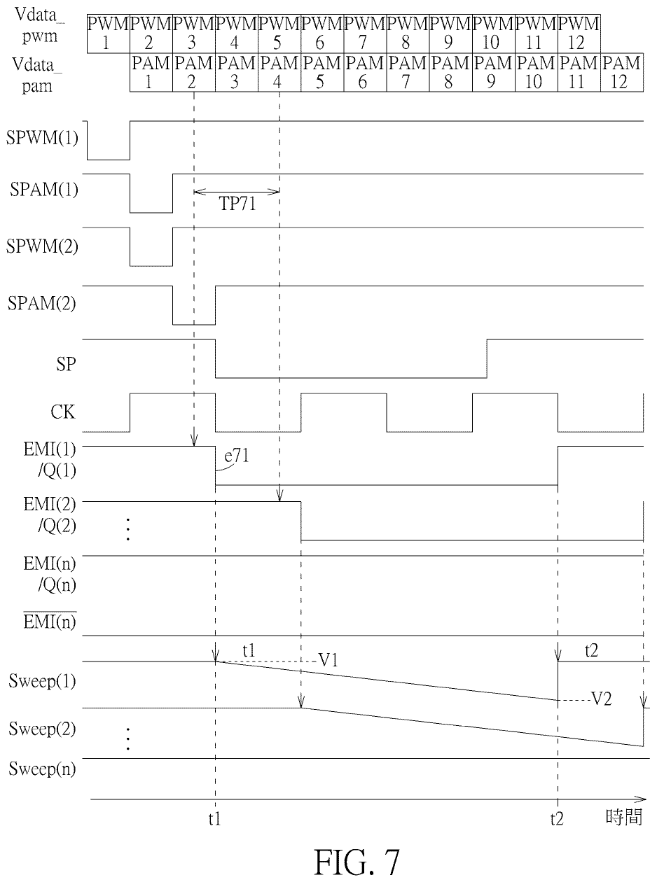

FIG. 7 is a signal waveform diagram of the circuit in FIG. 6. For the circuit in FIG. 6, the frequency of the clock signal CK in FIG. 7 can be adjusted to 1/2 times that of FIG. 3, resulting in a longer period. As shown in FIG. 7, after writing data PWM1 and data PWM2 through the PWM signal Vdata_pwm, and writing data PAM1 and data PAM2 through the PAM signal Vdata_pam, the circuit can be activated at the time t1, corresponding to the signal edge e71 of the first signal EMI(1). In other words, a single operation can write two pieces of data. The period TP71 in FIG. 7 can be half of a clock cycle, and this half cycle can correspond to two pieces of data. In FIG. 6 and FIG. 7, the sweep signal Sweep(1) begins to decrease after writing two pieces of data (e.g., data PWM1, data PAM1, data PWM2, data PAM2).

The one-to-two architecture in FIG. 6 is provided as an example. Based on the architecture in FIG. 6 and the control waveforms in FIG. 7, one-to-three, one-to-four, and other one-to-many architectures can be implemented. This means that a single sweep driver can be used to control multiple rows of electronic units.

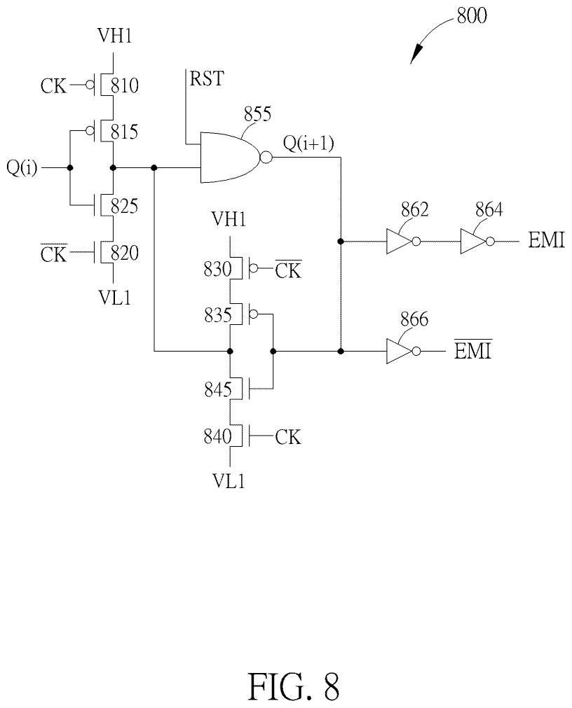

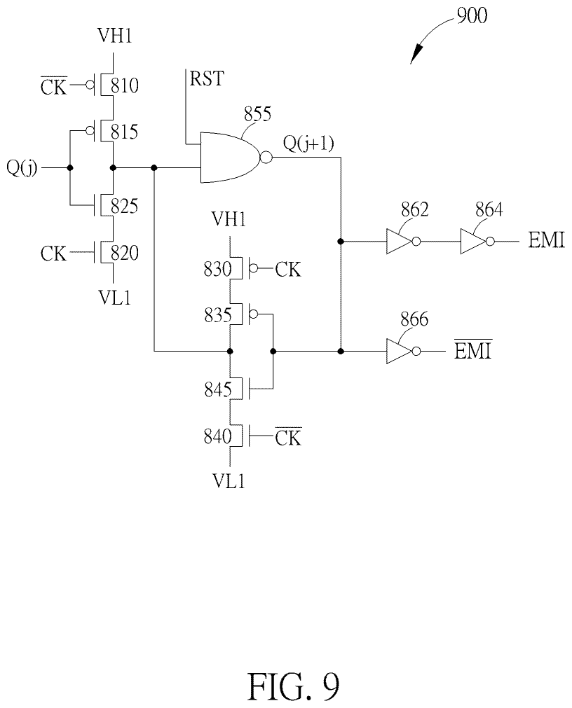

FIG. 8 is a schematic diagram of a shift register 800 that receives signals from an odd-numbered stage according to an embodiment. FIG. 9 is a schematic diagram of a shift register 900 that receives signals from an even-numbered stage according to an embodiment.

The shift register 800 can receive a signal Q(i) from an odd-numbered stage, where i is an odd number, such as 1, 3, 5, etc. The signal Q(i+1) generated by the shift register 800 can be inputted to a next-stage shift register. The signal Q(i+1) can be inputted to two inverters, the inverter 862 and the inverter 864, connected in cascade to generate the first signal EMI. The inverter 862 and the inverter 864 in FIG. 8 are examples, and they can be replaced with an even number of inverters connected in cascade, or a set of buffers, to provide driving capability and maintain the signal level. Therefore, the signal Q(i+1) can be approximately equal to the first signal EMI, with a very small phase difference between the two signals. This can be expressed as Q(i+1)≈EMI, or Q(i+1)=EMI.

The shift register 900 can receive a signal Q(j) from an even-numbered stage, where j is an even number, such as 2, 4, 6, etc. The signal Q(j+1) generated by the shift register 900 can be inputted to a next-stage shift register. Similar to FIG. 8, the signal Q(j+1) can be approximately equal to the first signal EMI. This can be expressed as Q(j+1)≈EMI, or Q(j+1)=EMI.

The shift register 800 can include the transistor 810, the transistor 815, the transistor 820, the transistor 825, the transistor 830, the transistor 835, the transistor 840, the transistor 845, the logic gate 855 (for example, it can be a NOR gate), the inverter 862, the inverter 864, and the inverter 866, coupled as shown in the figure. The shift register 800 can receive the voltage VH1, the voltage VL1, the signal RST, the clock signal CK, and the clock signal C̅K̅. The clock signal CK and the clock signal C̅K̅ can be complementary to each other. The voltage VH1 can be higher than the voltage VL1.

The circuit in FIG. 9 is similar to the circuit in FIG. 8, but with different clock signal arrangements. In FIG. 8, the transistor 810 and the transistor 840 receive the clock signal CK, while the transistor 820 and the transistor 830 receive the clock signal C̅K̅. In FIG. 9, the transistor 810 and the transistor 840 receive the clock signal C̅K̅, while the transistor 820 and the transistor 830 receive the clock signal CK.

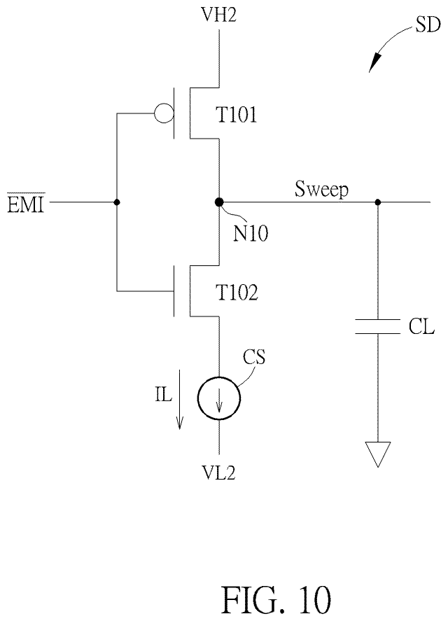

FIG. 10 is a schematic diagram of a sweep driver SD according to an embodiment. The sweep driver SD can be one of the sweep driver SD(1), the sweep driver SD(2), . . . , etc. in FIG. 1 and FIG. 6. The sweep driver SD can include the switch T101, the switch T102, and the current source CS connected in cascade, coupled as shown in FIG. 10. The sweep driver SD can receive the voltage VH2 and the voltage VL2. The voltage VH2 can be higher than the voltage VL2. The switch T101 and the switch T102 can include different types of transistors. For example, one of the switch T101 and the switch T102 can be a p-type transistor, and the other can be an n-type transistor. When one of the switch T101 and the switch T102 is turned on, the other can be turned off. The second signal EMI from the shift register can be inputted to the gate terminals of the switch T101 and the switch T102, and the node N10 between the switch T101 and the switch T102 can be used to output the sweep signal Sweep to a row of electronic units. The sweep driver SD can also include the capacitor CL coupled to the node N10. The current source CS can provide the current IL. The ratio of the current IL to the capacitance value of the capacitor CL can determine the slope of the sweep signal (for example, the sweep signal Sweep(1) in FIG. 3, FIG. 5, and FIG. 7) decreasing between the time t1 and the time t2. If the decreasing slope of the sweep signal Sweep is represented as the parameter slope, the relationship can be expressed as: slope ∝(IL/CL), or slope=(IL/CL). The time interval for the sweep signal Sweep to decrease can be determined by the waveform and pulse length of the first signal EMI and the second signal E̅M̅I̅.

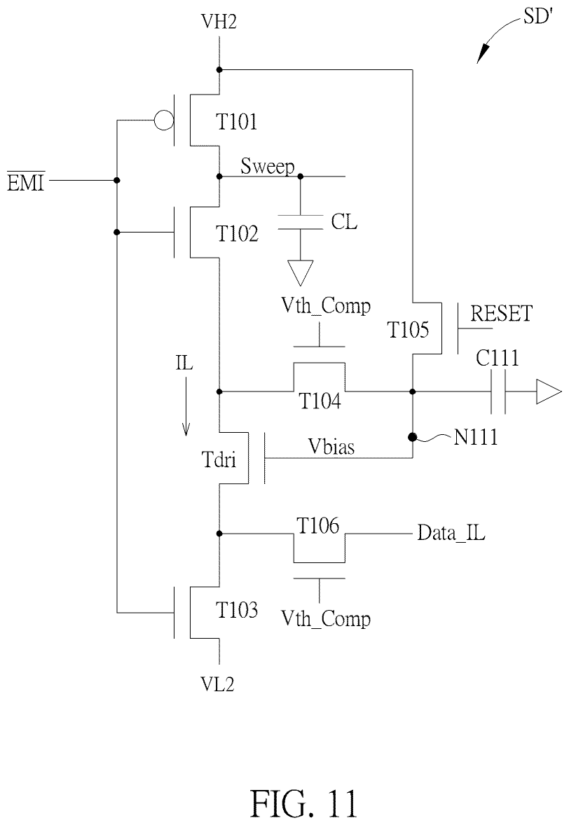

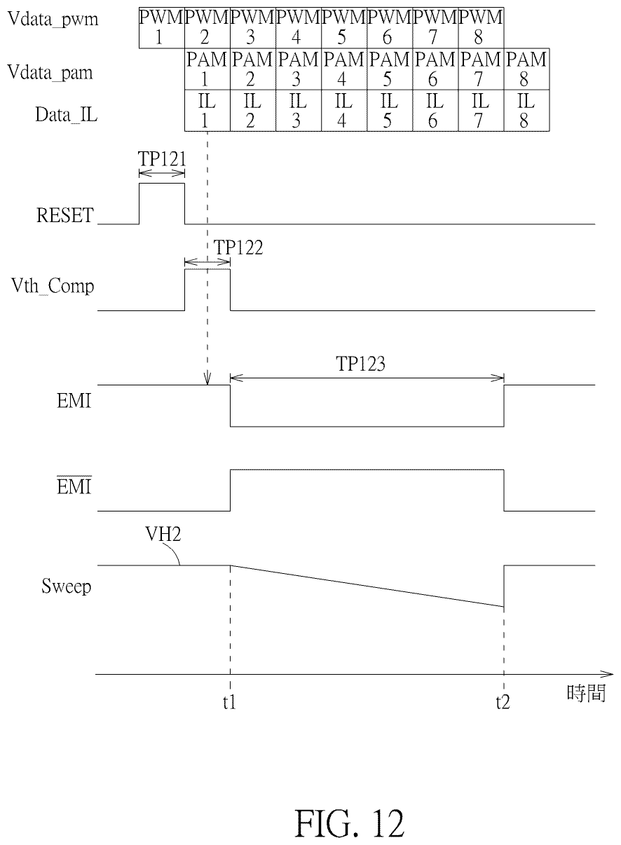

FIG. 11 is a schematic diagram of a sweep driver SD′ according to another embodiment. The sweep driver SD′ can be one type of architecture of the sweep driver SD. The sweep driver SD′ can have the function of compensating for the threshold voltage (commonly referred to as Vth) of the transistor. FIG. 12 is a timing diagram of signals of the sweep driver SD′ of FIG. 11. The sweep driver SD′ can include the transistor T101, the transistor T102, the transistor T103, the transistor T104, the transistor T105, the transistor T106, the transistor Tdri, the capacitor CL, and the capacitor C111. Regarding the transistor T101, the transistor T102, and the capacitor CL, they are similar to those in FIG. 10, so they will not be described repeatedly. The transistor T103, the transistor T104, the transistor T105, the transistor T106, and the transistor Tdri can be components of the current source CS in FIG. 10. The capacitor C111 can be coupled between the node N111 and a reference voltage terminal. The current source CS can receive the data signal Data_IL and generate the corresponding current IL based on the data signal Data_IL, as described below. As shown in FIG. 12, the data signal Data_IL can be used to sequentially provide data IL1, data IL2, data IL3, etc.

FIG. 11 and FIG. 12 show that during the period TP121, the transistor T105 is turned on, and the voltage VH2 can be written to the node N111, causing the voltage Vbias to have the high level of the voltage VH2, to perform a reset. At this time, the second signal EMI has not yet changed state, the transistor T101 can be turned on, and the sweep signal Sweep can be at a higher level (for example, the level of the voltage VH2) and has not yet begun to decrease.

During the period TP122, the transistor T104 and the transistor T106 can be turned on, and the data signal Data_IL (corresponding to the data IL1) can be inputted. The voltage Vbias at the node N111 can discharge with the current flowing through the transistor T104, the transistor T106, and the transistor Tdri. It gradually discharges to the sum (for example, 4 volts) of the signal level of the data signal Data_IL (for example, 3 volts) and the voltage drop across the transistor Tdri (for example, 1 volt). This achieves compensation for the threshold voltage, thereby reducing the impact of process variations.

During the period TP123, the transistor T102 and the transistor T103 can be turned on, and the sweep signal Sweep decreases, with the slope of the waveform being positively correlated with IL/CL. The sweep signal Sweep decreases in signal level as it discharges through the transistor T102 and the transistor T103, until the second signal E̅M̅I̅ transitions from a high level to a low level, at which point the signal level of the sweep signal Sweep returns to the high level of the voltage VH2.

The following describes the sequential operations in FIG. 11 and FIG. 12. When the second signal E̅M̅I̅ is at a low level, the transistor T101 is turned on, while the transistors T102 through T106 are turned off, and the sweep signal Sweep can be set to the high level of the voltage VH2.

When the second signal E̅M̅I̅ is at a low level, the reset signal RESET can have a pulse, and the voltage Vbias is set to the high level of the voltage VH2. At this time, the transistor T105 is turned on. The transistor T102, the transistor T103, the transistor T104, and the transistor T106 are turned off.

When the second signal E̅M̅I̅ is at a low level, the compensation signal Vth_Comp has a pulse. The transistor T104 and the transistor T106 are turned on, and the data signal Data_IL is lower than the voltage VH2. The voltage Vbias can be discharged to the sum of the data signal Data_IL and the threshold voltage of the transistor Tdri. It can be expressed as Vbias=Data_IL+Vth(Tdri). The transistor T102, the transistor T103, and the transistor T105 are turned off.

When the second signal EMI is at a high level, the transistor T101 can be turned off, while the transistor T102 and the transistor T103 can be turned on. At this time, the sweep signal Sweep can gradually decrease from the level of the voltage VH2 over time due to discharge, with the waveform slope being positively correlated with or equal to IL/CL. Until the second signal EMI changes state, the sweep signal Sweep can return to the level of the voltage VH2.

A brief description follows. Below, ΔV(Sweep) represents the voltage change of the sweep signal Sweep, ΔT represents the time duration, K represents a constant, IL represents the current value of the current IL, CL represents the capacitance value of the capacitor CL, and Data_IL represents the level value of the data signal Data_IL. Since ΔV(Sweep)*CL=IL*ΔT, the slope can be expressed as ΔV(Sweep)/ΔT=IL/CL. Therefore, IL=1/2*K*(Data_IL−VL2)². As described above, because the current IL is independent of the threshold voltage of the transistor Tdri, compensation can thus be achieved.

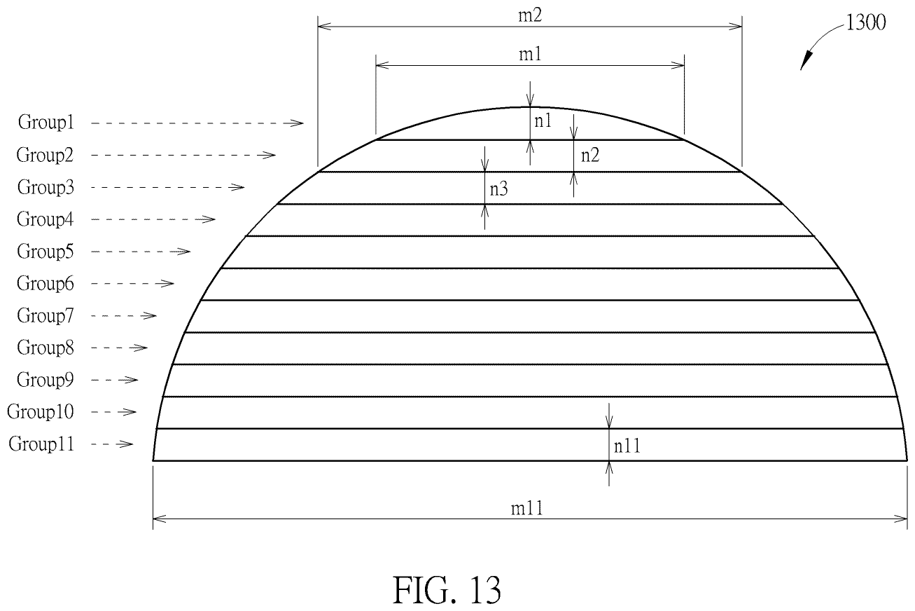

FIG. 13 is a schematic diagram of a display area 1300 according to an embodiment. For non-rectangular display areas like the display area 1300, each horizontal row has a different number of electronic units, resulting in different loads. For example, the rows of electronic units in the display area 1300 can be divided into 11 groups, including a group Group1 to a group Group11. Using FIG. 1 and FIG. 13 as examples, the rows of electronic units Row(1) to Row(n) can include a first row (for example, a row of electronic units in the group Group1) and a second row (for example, a row of electronic units in the group Group2). The number of electronic units in the first row can be less than the number of electronic units in the second row. The plurality of sweep drivers (for example, the sweep driver SD(1) to the sweep driver SD(n) in FIG. 1) can include a first sweep driver and a second sweep driver, where the first sweep driver can be electrically connected to the first row, and the second sweep driver can be electrically connected to the second row. The current source of the first sweep driver can be used to receive a first data signal, and the current source of the second sweep driver can be used to receive a second data signal, where the voltage of the first data signal can be different from (for example, less than) the voltage of the second data signal, to make the waveform slopes of the decreasing sweep signals substantially the same. Further explanation follows. In FIG. 13, the group Group1 can have n1 rows of electronic units, the group Group2 can have n2 rows of electronic units, and so on, with the group Group11 having n11 rows of electronic units. In this example, n1, n2, n3 . . . can be equal, that is, n1=n2=n3 . . . =n11, meaning each group has the same number of rows of electronic units. However, the length of the rows of electronic units in each group can be different. For example, the bottommost row of electronic units in the group Group1 can have m1 columns, meaning the bottommost row of electronic units in the group Group1 can have m1 pixels. The bottommost row of electronic units in the group Group2 can have m2 columns, and so on, with the bottommost row of electronic units in the group Group11 having m11 columns, where m1 to m11 can be different. Each group can be driven by one sweep driver. Because the lengths of the rows of electronic units in each group are different (that is, they have different numbers of pixels), the loads corresponding to each sweep driver are also different. Using the architecture in FIG. 11 as an example, for different sweep drivers, the loads corresponding to the capacitor CL can also be different. According to embodiments, the data signal Data_IL can be adjusted to make the waveform slopes of the decreasing levels of the sweep signals provided by multiple sweep drivers substantially the same.

In the sweep driver corresponding to the kth group Groupk, if the load value of the capacitor is represented as CLk, and the current value provided by the current source is represented as ILk, then ILk/CLk can be a constant. In FIG. 13, k can be 1, 2, 3, 4. . . 11. This can be expressed as IL1/CL1=IL2/CL2=IL3/CL3= . . . =IL11/CL11. Therefore, among the group Group1 through the group Group11, the waveform slopes of the decreasing levels of the sweep signals can be substantially the same. Here, IL1/CL1=IL2/CL2=IL3/CL3= . . . =IL11 /CL11 is used to illustrate the design target. According to the embodiments, the data signal Data_IL can be adjusted so that the variation in waveform slopes of the decreasing levels of sweep signals across different groups remains within ±5% of their average value.

When the sweep signal Sweep experiences interference or noise, the waveform may not decrease as expected, which can interfere with the control of transistors in the electronic units. This prevents the implementation of hybrid driving of PAM and PWM. The corresponding solution is described below.

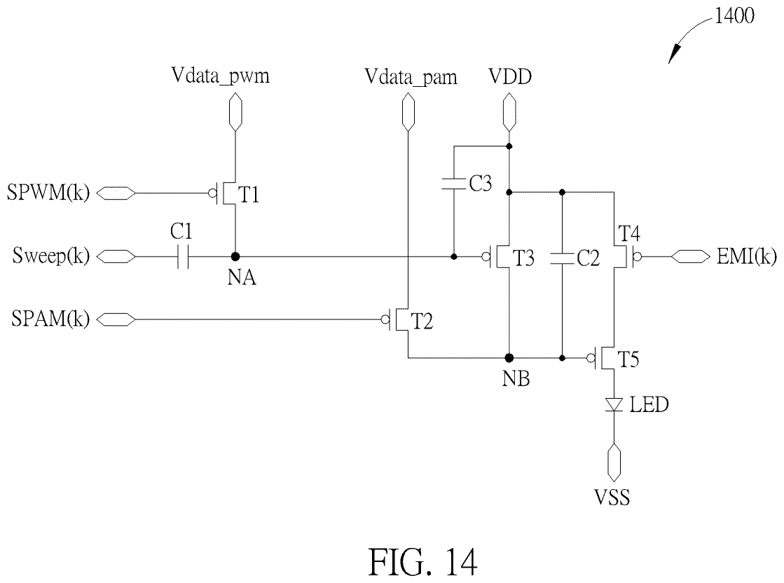

FIG. 14 is a schematic diagram of an electronic unit 1400 according to another embodiment. The electronic unit 1400 can be located in the kth row of electronic units Row(k). Using the architecture in FIG. 1 as an example, k can be any integer from 1 to n. The electronic unit 1400 can include the transistor T1 to the transistor T5, the capacitor C1 to the capacitor C3, and the light-emitting unit LED, coupled as shown in FIG. 14. The capacitor C3 in FIG. 14 can be used to effectively reduce the impact of interference. Since the electronic unit 1400 includes the capacitor C3, which is coupled between the node NA and the power signal VDD, when interference (represented as interference ΔV) appears in the sweep signal Sweep, the interference ΔV can be reduced to ΔV*C1/(C1+C3). In this formula, C1 can represent the capacitance value of the capacitor C1, and C3 can represent the capacitance value of the capacitor C3. For example, if the capacitance values of the capacitor C1 and the capacitor C3 are equal, by using the capacitor C3, the interference ΔV can be reduced to 50%. According to embodiments, the ratio of the capacitor C1 and the capacitor C3 can be adjusted to make C1/(C1+C3)<75%.

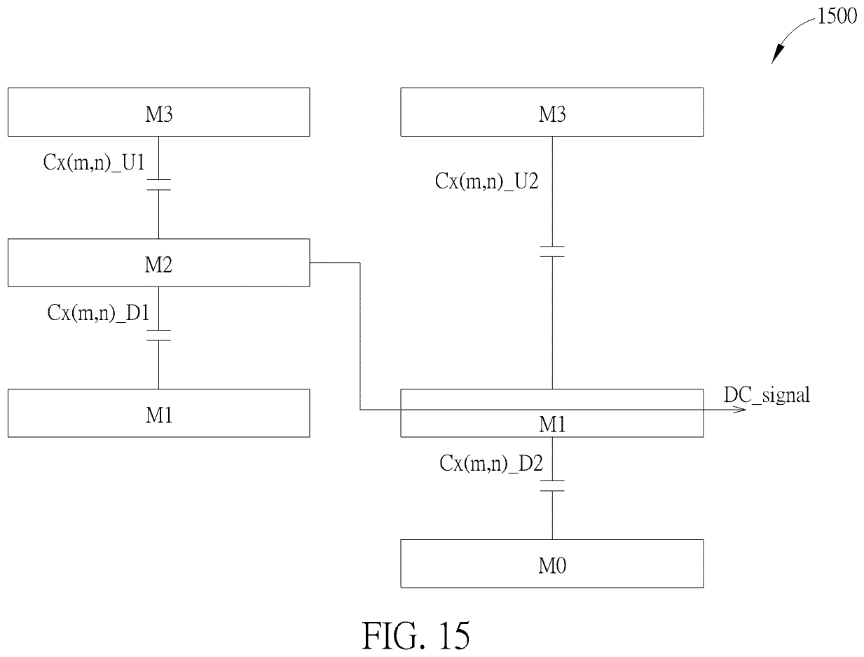

FIG. 15 is a cross-sectional schematic diagram of the structure of an electronic unit 1500 according to an embodiment. FIG. 15 is a simplified schematic diagram used to explain the principle. The structure in FIG. 15 can be applied to the electronic unit Pix(1,1) to the electronic unit Pix(m,n), the electronic unit Pix, and the electronic unit Pix′ mentioned above. As shown in FIG. 15, in the cross-sectional view, a direct-current shielding line can be used. The direct-current shielding line can be located between at least one sweep signal line (for example, the transmission line of the sweep signal Sweep) and multiple first data lines (for example, the transmission lines of the PAM signal Vdata_pam). Additionally, the direct-current shielding line can be located between the at least one sweep signal line and the multiple second data lines (for example, the transmission lines of the PWM signal Vdata_pwm). The direct-current shielding line can be used to receive a direct-current signal DC_signal. The direct-current signal DC_signal can be the power signal VDD or the ground signal VSS. This can be expressed as DC_signal=VDD, or DC_signal=VSS. Related details are described below.

As shown on the left side of FIG. 15, the aforementioned PWM signal Vdata_pwm and PAM signal Vdata_pam can be transmitted through a conductive layer M3. The sweep signal Sweep can be transmitted through a conductive layer M1. Between the conductive layer M3 and the conductive layer M1, a conductive layer M2 can be formed. The conductive layer M2 can be coupled to the direct-current signal DC_signal for direct-current shielding. Parasitic capacitance Cx(m,n)_U1 may exist between the conductive layer M3 and the conductive layer M2. Parasitic capacitance Cx(m,n)_D1 may exist between the conductive layer M2 and the conductive layer M1. Here, m and n represent the electronic unit's position in the mth column and nth row.

As shown on the right side of FIG. 15, the PWM signal Vdata_pwm and PAM signal Vdata_pam can be transmitted through the conductive layer M3. The sweep signal Sweep can be transmitted through a conductive layer M0. The conductive layer M1 can be formed between the conductive layer M3 and the conductive layer M0. The conductive layer M1 can be coupled to the direct-current signal DC_signal for direct-current shielding. Parasitic capacitance Cx(m,n)_U2 may exist between the conductive layer M3 and the conductive layer M1, and parasitic capacitance Cx(m,n)_D2 may exist between the conductive layer M1 and the conductive layer M0. Here, m and n represent the electronic unit's position in the mth column and nth row.

The left and right sides of FIG. 15 present two distinct hardware design approaches for direct-current shielding to reduce noise and interference in sweep signals. Depending on semiconductor manufacturing processes and layout requirements, the two approaches can be flexibly implemented, either individually selected or concurrently used within electronic units to reduce interference effects and potentially enhance overall performance.

The electronic devices 100 and 600 implement a hybrid driving circuit that processes both pulse amplitude modulation (PAM) and pulse width modulation (PWM) signals. This hybrid approach combines PAM's continuous current stability with PWM's color precision, achieving enhanced driving performance with improved precision, stability, and efficiency while overcoming the limitations of single-mode driving methods.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. An electronic device, comprising:
a plurality of rows of electronic units, each row of electronic units comprising a plurality of electronic units;
a plurality of sweep drivers, each sweep driver being electrically connected to at least one row of the plurality of rows of electronic units; and
a plurality of shift registers, electrically connected in a cascade manner to form a multi-stage structure, each shift register being configured to provide a first signal to at least one row of the plurality of rows of electronic units, and provide a second signal to one of the plurality of sweep drivers;
wherein each sweep driver outputs a sweep signal to at least one row of the plurality of rows of electronic units based on the second signal.

2. The electronic device of claim 1, wherein a first stage shift register of the plurality of shift registers is configured to receive a start signal and provide a signal to a second stage shift register following the first stage shift register.

3. The electronic device of claim 1, wherein the first signal and the second signal are complementary to each other.

4. The electronic device of claim 1, wherein each shift register of the plurality of shift registers outputs the first signal to at least two rows of the plurality of rows of electronic units, and each sweep driver outputs the sweep signal to at least two rows of the plurality of rows of electronic units.

5. The electronic device of claim 1, wherein the first signal includes a pulse between a first time and a second time, and the sweep signal transitions from a first voltage to a second voltage with a predetermined slope between the first time and the second time.

6. The electronic device of claim 5, wherein the predetermined slope is determined according to a current value and a capacitance value.

7. The electronic device of claim 6, wherein the predetermined slope is determined according to a quotient of the current value divided by the capacitance value.

8. The electronic device of claim 1, wherein:
each sweep driver comprises a first switch, a second switch, and a current source electrically connected in a cascade manner;
the first switch and the second switch comprise different types of transistors; and
the second signal is input to gate terminals of the first switch and the second switch, and a node disposed between the first switch and the second switch is configured to output the sweep signal.

9. The electronic device of claim 8, wherein the current source is configured to receive a data signal and generate a corresponding current based on the data signal.

10. The electronic device of claim 9, wherein the plurality of rows of electronic units comprise a first row and a second row, a number of electronic units in the first row is less than a number of electronic units in the second row, the plurality of sweep drivers comprise a first sweep driver and a second sweep driver, the first sweep driver is electrically connected to the first row, and the second sweep driver is electrically connected to the second row.

11. The electronic device of claim 10, wherein a current source of the first sweep driver is configured to receive a first data signal, a current source of the second sweep driver is configured to receive a second data signal, and a voltage of the first data signal is different from a voltage of the second data signal.

12. The electronic device of claim 11, wherein the voltage of the first data signal is lower than the voltage of the second data signal.

13. The electronic device of claim 1, wherein the electronic device further comprises a plurality of first data lines and a plurality of second data lines, the plurality of first data lines are configured to provide pulse amplitude modulation signals to a plurality of electronic units, and the plurality of second data lines are configured to provide pulse width modulation signals to the plurality of electronic units.

14. The electronic device of claim 13, wherein each sweep driver is electrically connected to at least one row of the plurality of rows of electronic units through at least one sweep signal line, and the at least one sweep signal line intersects with the plurality of first data lines and the plurality of second data lines.

15. The electronic device of claim 14, wherein:
each electronic unit comprises a first capacitor, a second capacitor, a first transistor, a second transistor, and a third transistor;
a first terminal of the first capacitor is configured to receive a sweep signal, the first transistor is configured to receive a pulse width modulation signal, the second transistor is configured to receive a pulse amplitude modulation signal; and
the first transistor and the second capacitor are coupled to a first node between a second terminal of the first capacitor and the third transistor, and the second transistor and the third transistor are coupled to a second node.

16. The electronic device of claim 14, further comprising a direct-current shielding line, wherein in a cross-sectional view, the direct-current shielding line is located between the at least one sweep signal line and the plurality of first data lines, and between the at least one sweep signal line and the plurality of second data lines.

17. The electronic device of claim 16, wherein the direct-current shielding line is configured to receive a power signal.

18. The electronic device of claim 16, wherein the direct-current shielding line is configured to receive a ground signal.

19. The electronic device of claim 1, wherein each of the plurality of electronic units comprises a pixel circuit.

20. The electronic device of claim 1, wherein each of the plurality of electronic units comprises a portion of a pixel circuit.
